(19) United States
(12) Patent Application Publication
(10) Pub. No.: US 2011/0006698 A1
(43) Pub. Date: Jan. 13, 2011

(54) OVERLOAD PROTECTION

(75) Inventors: Wilhelmus Hinderikus Langeslag, Wijchen (NL); Arijan van den Berg, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/834,625

(22) Filed: Jul. 12, 2010

(30) Foreign Application Priority Data
Jul. 13, 2009 (EP) 09165322.0

(51) Int. Cl. H05B 41/36

(52) U.S. Cl. 315/226

(57) ABSTRACT

An overload protection circuit and method for a fluorescent lamp drive circuit is presented, the fluorescent lamp drive circuit having first and second switches connected in series and a controller adapted to switch the switches on and off alternately. The overload protection circuit is adapted to detect a voltage across the first switch, and to turn off the first switch based on whether the detected voltage exceeds a first threshold voltage.

The present invention relates to overload protection for an electronic circuit and, more particularly to overload protection for a fluorescent lamp drive circuit.

A fluorescent lamp or fluorescent tube is a gas-discharge lamp that uses electricity to excite mercury vapor. The excited mercury atoms produce short-wave ultraviolet light that then causes a phosphor to fluoresce, producing visible light. Unlike incandescent lamps, fluorescent lamps require an auxiliary device, a ballast, to regulate the current flow through the lamp.

Drive circuits are employed to start and run fluorescent lamps. The choice of drive circuit is based on factors such as mains voltage, tube length, initial cost, long term cost, instant versus non-instant starting, temperature ranges and parts availability, etc.

Fluorescent lamps can run directly from a DC supply of sufficient voltage to strike an arc. However, fluorescent lamps are typically never operated directly from DC. Instead, an inverter is normally used to convert a DC supply into an AC supply and to provide a current-limiting function.

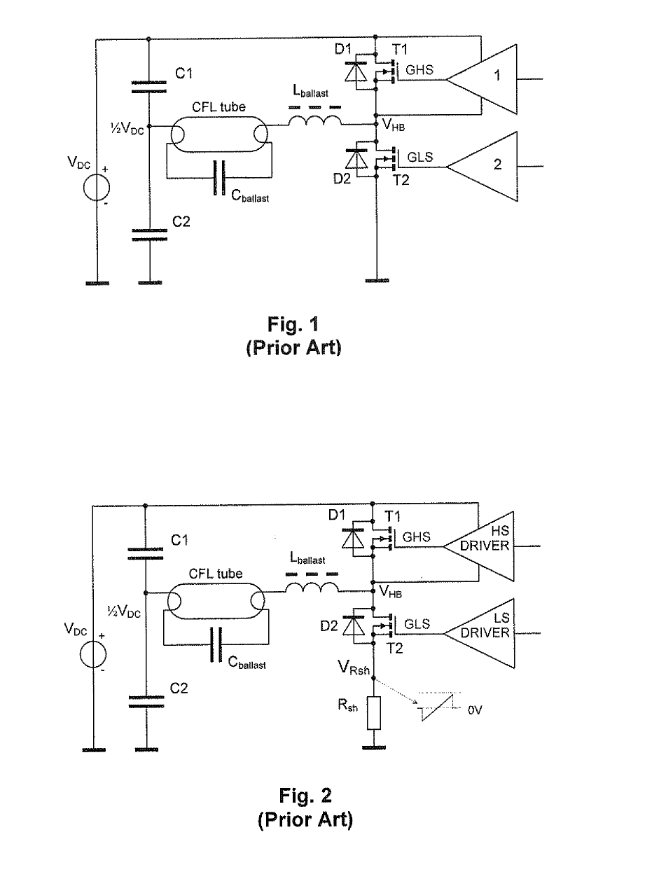

FIG. 1 shows a typical fluorescent lamp drive circuit. Here, a halfbridge arrangement is provided with a pair of MOSFET switching elements T1,T2 connected in series, driver circuits 1,2 for controlling the MOSFET switching elements T1,T2 to switch on and off alternately, and fly wheel diodes D1, D2 connected in inverse parallel with the switching elements T1,T2.

In general, the halfbridge circuit starts oscillating at the maximum frequency. During ignition of the fluorescent lamp (CFL tube), the frequency sweeps down. The voltage across the CFL tube increases, but also the current through the switching elements T1,T2 and coil increases.

For such circuits which use lateral devices, the high currents during ignition cannot be handled well. Lateral devices are devices that have the source and the drain at the same side of the silicon. These devices can be integrated which a control chip. Vertical devices, on the other hand, typically have the source and drain on opposite sides of the silicon (eg. the source on the top side and the drain at the bottom side). Vertical devices can generally handle more current than lateral devices, but cannot be integrated with a control chip.

At high currents, a MOSFET enters a saturation mode, which results in a high voltage across the MOSFET and a high current through the MOSFET, resulting in damage to the device.

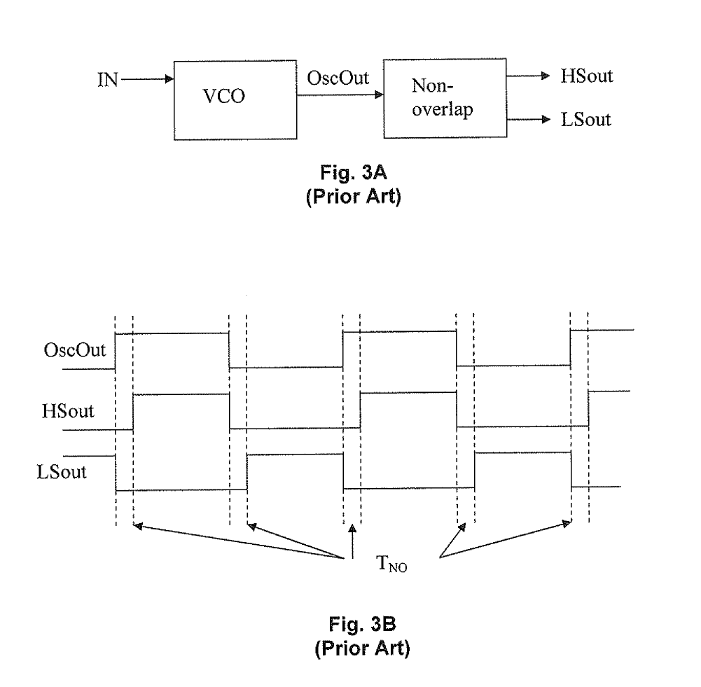

It is already known to limit the current through the low-side switching element (T2) by measuring the current through the switching element T2 using a resistor Rsh, as illustrated in FIG. 2. Here, when the current through the resistor Rsh of the low-side switching element T2 becomes too high, a mechanism is started to turn off the low-side switching element T2. Several ways to do this are known and will not be described in any detail here. For vertical MOSFETs, this approach has been shown to adequately protect a low-side MOSFET. This is because vertical devices can handle higher currents than lateral devices.

However, for monolithic integrated circuits, switching elements are typically lateral devices and the maximum current capability is limited. In some cases, the size of the MOSFET switching elements is not determined by the on-resistance of the MOSFET, but by the maximum current capability.

As mentioned above, for fluorescent lamp applications, the maximum current during ignition can be very high. Accordingly, it is desirable to reduce device size and use a MOSFET switch as close as possible to its maximum current (i.e. the saturation current of the MOSFET).

Embodiments detect when a FET switch enters a saturation region and control the circuit the reset a controller and switch off the FET. Thus, the invention enables a reduction in circuit size since the size of the switches can be reduced as a result of the current through the switches being limited.

Embodiments provide an overload protection circuit for a fluorescent lamp drive circuit having first and second switches connected in series and a controller adapted to switch the switches on and off alternately, the overload protection circuit being adapted to turn off a switch if the voltage across the switch is greater than a threshold voltage.

According to an aspect of the invention, there is provided an overload protection circuit for a fluorescent lamp drive circuit having first and second switches connected in series and a controller adapted to switch the switches on and off alternately, the overload protection circuit being adapted to detect a voltage across the first switch, and to turn off the first switch based on whether the detected voltage exceeds a first threshold voltage.

According to another aspect of the invention, there is provided a circuit overload protection method overload for use with a fluorescent lamp drive circuit having first and second switches connected in series and a controller adapted to switch the switches on and off alternately, the method comprising the steps of: detecting a voltage across the first switch; determining if the detected voltage exceeds a first threshold voltage; and turning off the first switch based on whether the detected voltage is determined to exceed the first threshold voltage.

For a better understanding of the invention, embodiments will now be described, purely by way of example, with reference to the accompanying drawings, in which:

FIG. 1 is a circuit diagram of a conventional fluorescent lamp drive circuit;

FIG. 2 is a circuit diagram of another conventional fluorescent lamp drive circuit;

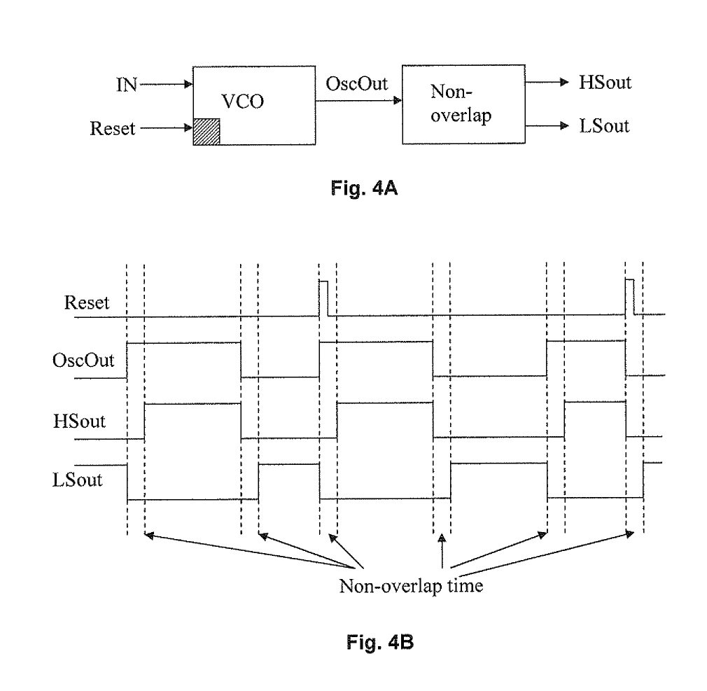

FIG. 3a is a block diagram of an oscillator circuit for the conventional fluorescent lamp driver circuit of FIG. 1;

FIG. 3b illustrates the output signals of the oscillator circuit of FIG. 3a;

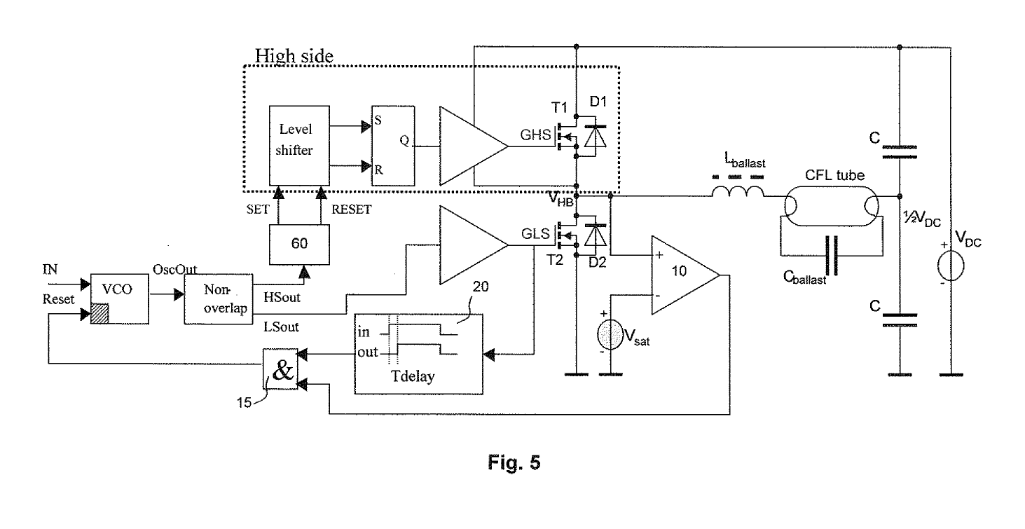

FIG. 4a is a block diagram of an oscillator circuit according to an embodiment of the invention;

FIG. 4b illustrates the output signals of the oscillator circuit of FIG. 4a.

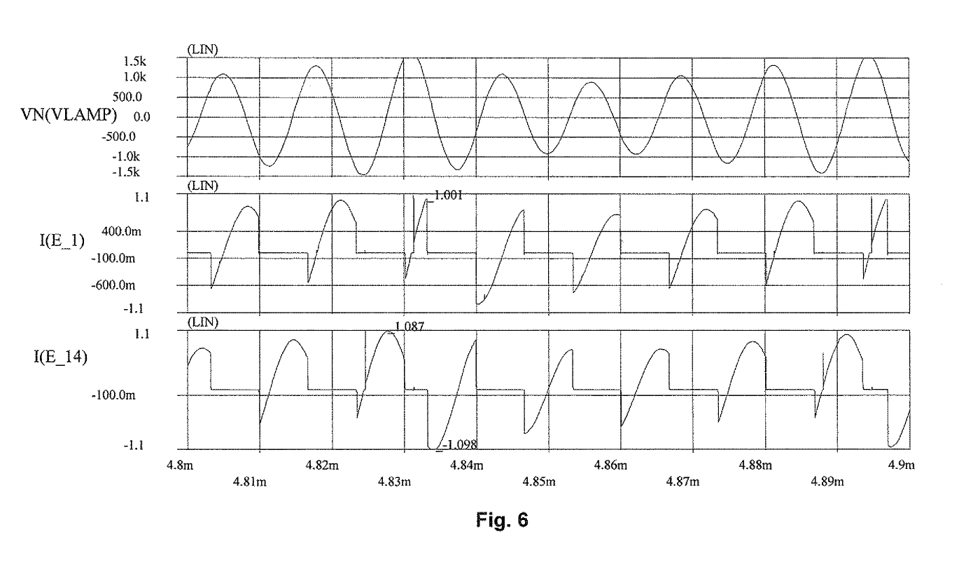

FIG. 5 is a circuit diagram of a fluorescent lamp drive circuit according to an embodiment of the invention;

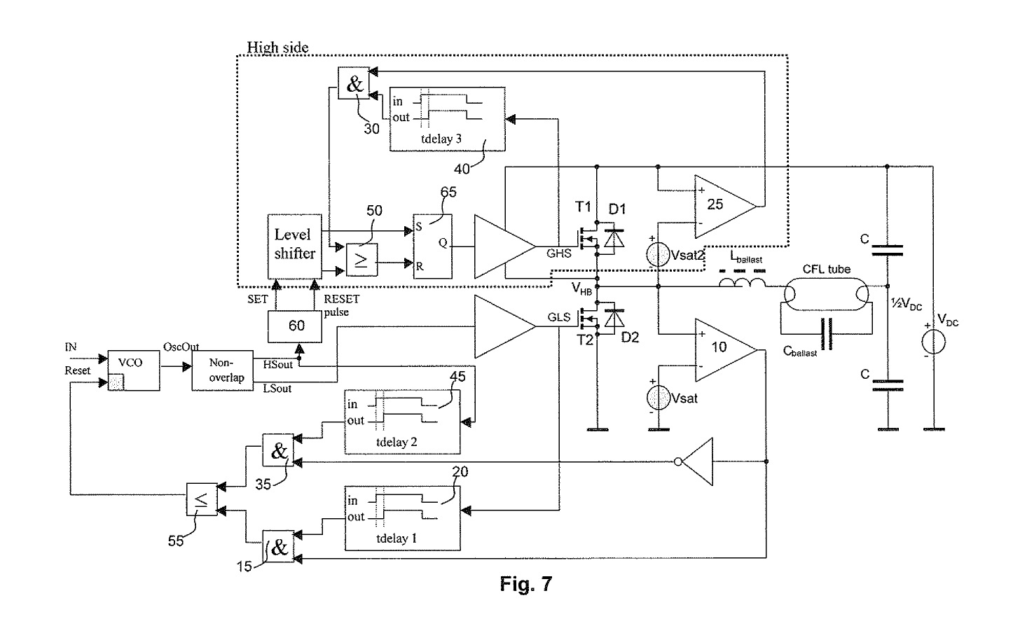

FIG. 6 is an illustration of simulation results of the circuit of FIG. 5;

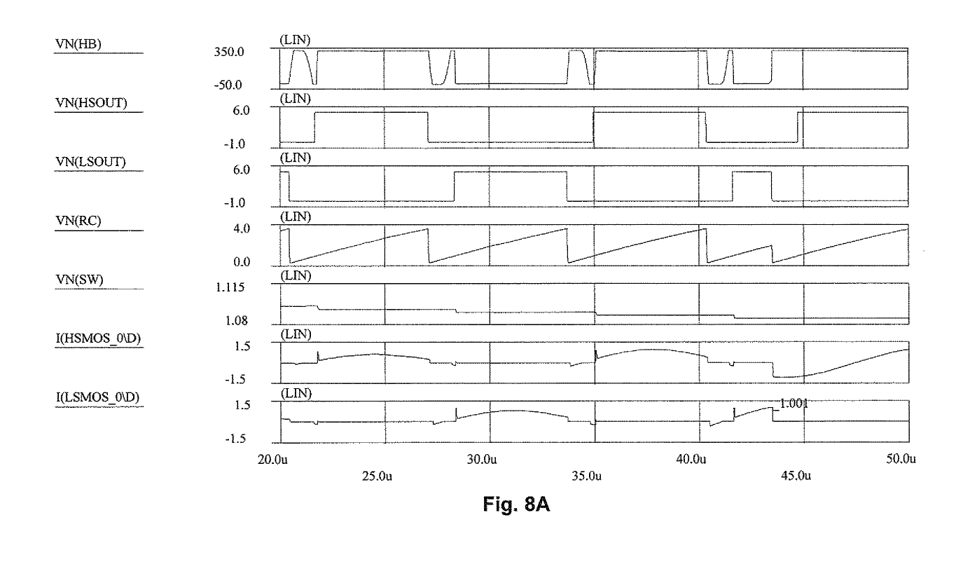

FIG. 7 is a circuit diagram of a fluorescent lamp drive circuit according to another embodiment of the invention; and

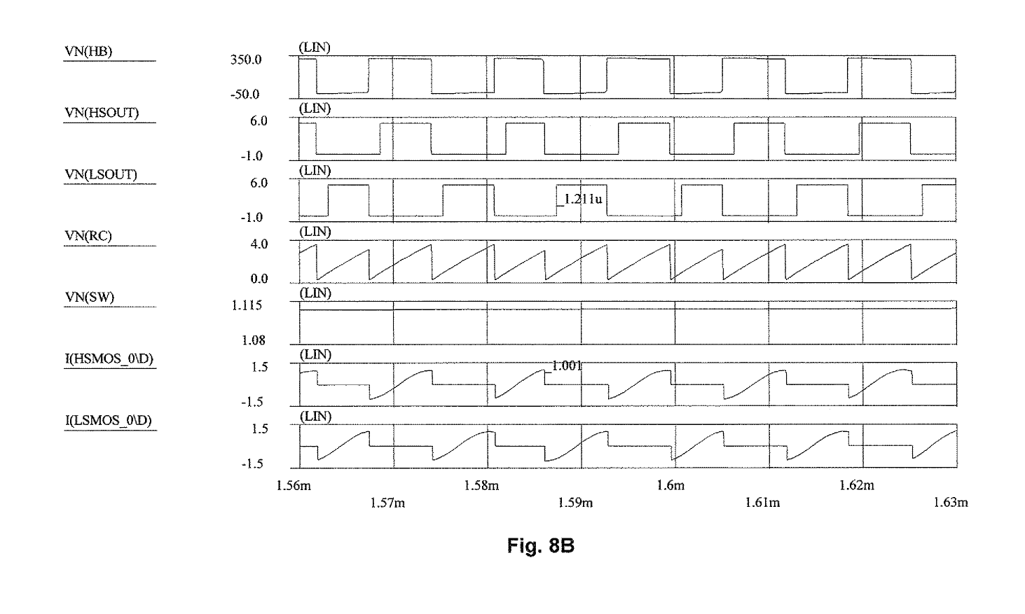

FIGS. 8A and 8B illustrate simulation results of the circuit of FIG. 7.

Embodiments provide overload protection for a fluorescent lamp drive circuit in which the maximum current during lamp ignition can be very high. In doing so, the drive circuit may be reduced in size and the switches operated close to a maximum current (i.e. at a MOSFET the saturation current).

To decrease the size of the switches in the drive circuit, one can measure the voltage across a switch and turn off the switch when the voltage across the switch becomes too large. Here, a MOSFET switch can be permitted to first enter the saturation mode before reacting and switching it off. In this way, a spread and temperature dependency of the detection current and the saturation current does not to be accounted for.

Typically, in fluorescent lamp drive circuits, only the low-side switch is protected. One can extend the concept above by also measuring the voltage across the high-side switch.

It has been found that, when lateral devices are used, limiting the current of the high-side switch results in the smallest size/area requirements. Indeed, simulations have shown that when only the low-side switch is protected, the high-side switch needs to have at least 10% more current capability (and hence a larger area).

Preferably, when the switch is turned off, the oscillator is reset to ensure the halfbridge arrangement continues to operate correctly. For the low-side switch, this can be done as explained with reference to FIG. 5 below. For the high-side switch, information that the high-side switch is turned off is required to be communicated to low-side where the oscillator is located. For this additionally circuitry can be implemented (as explained with reference to FIG. 7 below), but it will be appreciated that this results in increased area requirements because high voltage circuits are typically large.

When the high-side switch is turned off (because the current through the switch is too high), the voltage VHB (see FIG. 1) between the two switches drops. Thus, to protect the low-side switch, a comparator arrangement (as illustrated in FIG. 7, for example) is used that senses the voltage VHB. When the voltage VHB is low and the high-side switch should be on, the oscillator is reset. In this way, a low-side comparator may be used for 2 functions: protecting the low-side switch and resetting the oscillator when the high-side switch is turned off as result of detected saturation.

Turning now to FIGS. 3 to 5, an exemplary embodiment of the invention will now explained.

Firstly, the output signals of an oscillator circuit for a conventional fluorescent lamp driver circuit (like that of FIG. 1) will be described with reference to FIGS. 3a and 3b. A shown in FIG. 3a, a DC input voltage (IN) is provided to a voltage controlled oscillator (VCO). The oscillator frequency is determined by this DC input voltage (IN). The output (OscOut) of the VCO is provided to a non-overlap circuit which generates the signals, HSout and LSout, that are used drive the gate of the high-side (T1) and the low-side (T2) switches, respectively.

As shown in FIG. 3b, the gate drive signals, HSout and LSout, are generated with non-overlap time, T_{NO}. This non-overlap time T_{NO} can be fixed or variable according to requirements.

Turning now to FIGS. 4a and 4b, an embodiment of the invention is adapted to reset the VCO using a Reset input signal. As will be understood from FIG. 4b, when a Reset pulse is generated (i.e. when the Reset input goes from a low voltage state to a high voltage state for a short period of time), the switch that is on at the time of application of the reset pulse is turned off After the non-overlap time, T_{NO}, the other switch is then turned on.

In FIG. 4, upon application of the first reset pulse (with the value of time passed increasing from the left hand side of the diagram to the right hand side), the low-side switch, T2, is turned off (as can be seen from LSout changing from a high “on” state to a low “off” state). Upon application of the second reset pulse, the high-side switch, T1, is turned off (as can be seen from HSout changing from a high “on” state to a low “off” state).

Applying the concept above to the conventional circuit of FIG. 1, (so as to reset the controller if the voltage across the low-side switch T2 is greater than a threshold voltage), a circuit according to an embodiment of the invention can be provided. Such an embodiment is illustrated in FIG. 5.

From a comparison of the conventional circuit of FIG. 1 and the embodiment of FIG. 5, it will be appreciated that the circuits are similar in design, expect for the additional provision of a reference voltage source Vsat, a comparator 10, an AND gate 15, a rising edge delay unit 20 (providing a time delay of Tdelay for a rising edge of a signal, i.e. a signal transition from a low “off” to high “on” state), and a VCO reset input RESET in the embodiment of the invention.

The voltage comparator 10 is adapted to compare the voltage VHB across the low-side MOSFET switch T2 with the reference voltage Vsat. The output signal of the voltage comparator 10 is provided as a first input of the AND gate 15, and the gate voltage GLS of the low-side switch is provided to a second input of the AND gate 15 via the delay unit 20. The output of the AND gate 15 is provided as the VCO reset input signal RESET. In this way, the circuit comprises a protection circuit which is adapted to reset the controller if the voltage VHB across the low-side MOSFET switch T2 is greater than a threshold reference voltage Vsat.

In this embodiment, a comparator 10 is adapted to measure the voltage VHB across the low-side MOSFET switch T2. When the MOSFET T2 goes into saturation, the voltage VHB across the switch will increase. The Vsat value is chosen in such a way that the value is only reached when the MOSFET goes into saturation. In this way the circuit gives no limitation for igniting the lamp.

By arranging the threshold reference voltage Vsat to be substantially equal to the saturation of the low-side MOSFET switch T2, the low-side MOSFET switch can be controlled to be switched off when it enters the saturation mode. Thus, when the voltage VHB across the low-side MOSFET switch T2 is greater than the reference voltage Vsat and the delayed gate voltage GLS of the low-side switch is in the high “on” state, the VCO is reset which, in turn, switches off the low-side switch. It is preferred to provide the time delay, Tdelay, because when the low-side switch is turned on the voltage across the switch is not always below the reference voltage Vsat. By waiting a short time period so that under all conditions the voltage is below Vsat, one can ensure that the current of the low-side switch is always below its saturation current.

Referring now to FIG. 6, simulation results of the circuit of FIG. 5 are shown. Here the maximum current through the low-side MOSFET switch T2 is limited to 1 A. The current through the high-side switch is not limited. The current I(E_1) is the current through the low-side MOSFET switch T2, and the current I(E_14) is the current through the high-side switch T1. It can be seen from FIG. 5 that when the current I(E_1) reaches 1A, the low-side MOSFET switch T2 is turned off so that the current I(E_1) is limited to not exceeding 1A.

Also, from the simulation results, it can be seen that when the current of the low-side MOSFET switch T2 is limited to 1 A, the maximum current through the high-side switch is limited to 1.087 A. Thus, when the high-side switch has 10% more current capability than the low-side switch, saturation protection for the low-side MOSFET switch T2 provides adequate overload protection. Nonetheless, asymmetrical currents in the halfbridge during ignition may still present problems.

The concept of the invention can be further extended in an attempt to make the switches as small as possible and provide a circuit which is insensitive to asymmetrical currents in the halfbridge. Such a preferred embodiment is shown in FIG. 7, wherein the low-side the circuit is similar to that of FIG. 5, and wherein the high-side of the circuit comprises further components in an arrangement which mirrors that of the low-side and provides a connection between the high-side and the low-side.

From a comparison of the embodiment of FIG. 5 and the embodiment of FIG. 7, it will be appreciated that the circuits are similar in design, expect for the additional provision of a second reference voltage source Vsat2, a second comparator 25, second 30 and third 35 AND gates, a second 40 and third 45 edge delaying units (each providing a time delay of Tdelay for a rising edge of a signal), and first 50 and second 550R gates.

The second voltage comparator 25 is adapted to compare the voltage (V_{AC}-VHB) across the high-side switch T1 with the reference voltage Vsat2. The output signal of the second voltage comparator 25 is provided as a first input of the second AND gate 30, and the gate voltage GHS of the high-side switch is provided to a second input of the second AND gate 30 via the second delay unit 40. The output of the second AND gate 30 is provided as a first input to the first OR gate 50, and the second input of the first OR gate 50 is the reset pulse from the level shifter. In this way, the circuit comprises a protection circuit which is adapted to turn off the high side switch T1 if the voltage across the high-side switch T1 is greater than the threshold reference voltage Vsat2.

From FIG. 7 it will also been seen that the low-side configuration differs from that of the circuit of FIG. 5 in that the second OR gate 55 is connected between the output of the first AND gate 15 and the Reset input signal of the VCO. The first input of the second OR gate 55 is provided from the output of the first AND gate 15, and the second input of the second OR gate 55 is provided from the third AND gate 35. The third AND gate 35 has two input, the first being an inverted output signal of the low-side comparator 10, and the second being a edge delayed version of the low-side version of the high-side drive signal HSout provided via the third delay unit 45.

The high-side switch T1 is turned on by a set pulse from a pulse circuit 60 of the controller. This pulse sets the high-side latch 65. The high-side switch is also turned off by a pulse. When the voltage across the high-side switch T1 becomes too high (i.e. greater than Vsat2) and the high-side switch T1 is already on for time tdelay3, the high latch 65 is reset and, in turn, the high-side switch turned off. The time Tdelay3 is provided because when the high-side switch T1 is switched on, the voltage across the switch is not always below the reference voltage Vsat2. Waiting a short time period Tdelay3 ensures that, under all conditions, the voltage is below Vsat2.

Preferably, for correct operation of the circuit, the VCO is reset when the high-side switch is turned off because the voltage across it is too high. Thus, the embodiment of FIG. 7 is designed to communicate the high-side switch T1 turn off information to the low-side of the circuit. However, in general high voltage circuits are quite large and so this arrangement is simply preferred. Indeed, for embodiments where the VCO is not reset when the high-side switch is turned off because the voltage across it is too high, adequate overload protection is provided, but circuit behavior may not be optimal.

In FIG. 7, the communication that the high-side transistor T1 is turned off employs components of the low-side protection arrangement, thereby resulting in space/area savings. Generally, when the high-side switch T1 is on, the voltage across the low-side comparator is high. Thus, when under this condition the voltage across the low-side comparator 10 is lower than Vsat and the delayed HSout signal is still high, it is assumed that the high-side switch is turned off, because of saturation (The HSout signal normally turns on and turns off the high side switch. Thus, when the HSout signal is high, the high side switch should be on, but the voltage on the VHB being low means that the saturation protection has turned off the high side switch and not HSout). Accordingly, an inverted output signal of the low-side comparator 10 is used to indicate that the voltage across the low-side comparator 10 is lower than Vsat and that the high-side switch is turned off.

The third delay unit 45 is employed to provide a time delay for a rising edge of the high-side drive signal HSout, because when the high-side switch is turned on, the requirement that the voltage across the low-side comparator is higher than Vsat is not always fulfilled. Here, the actual gate drive voltage GHS is not used to determine if the high-side switch is on, but rather the drive signal HSout is used (which makes control the gate drive voltage GHS via the S-R latch 60).

Referring now to FIGS. 8A and 8B, simulation results of the circuit of FIG. 7 are shown. From FIG. 8A, it can be seen that the current (LSMOS) of the low-side switch T2 is limited to 1 A. The low-side switch T2 is turned off and the VCO is reset (the RC voltage does not reach its maximum value). From FIG. 8B, it can be seen that the current (HSMOS) of the high-side switch T1 is limited to 1 A. When the high-side switch T1 is turned off, the VCO is reset (the RC voltage does not reach its maximum value).

Preferably, to provide for low switching losses during ignition of the fluorescent tube, the saturation current can be combined with a capacitive mode or hard switching protection. These protections increase the frequency when capacitive mode or hard switching is detected. By increasing the frequency not only the hard switching is reduced, but also the peak current through the switches is reduced.

Embodiments can be employed for compact fluorescent lamp (CFL) and tube lamp (TL) applications where the current through switch(s) is limited during ignition.

While specific embodiments have been described herein for purposes of illustration, various modifications will be apparent to a person skilled in the art and may be made without departing from the scope of the invention.

1. An overload protection circuit for a fluorescent lamp drive circuit having first and second switches connected in series and a controller adapted to switch the switches on and off alternately,
the overload protection circuit being adapted to detect a voltage across the first switch, and to turn off the first switch based on whether the detected voltage exceeds a first threshold voltage.

2. The overload protection circuit of claim 1, wherein the controller comprises an oscillator arrangement having a reset input, and wherein the overload protection circuit is further adapted to reset the oscillator arrangement based on whether the detected voltage exceeds a first threshold voltage.

3. The overload protection circuit of claim 1, wherein the first and second switches comprises first and second FETs.

4. The overload protection circuit of claim 1, comprising a first edge delay unit adapted to delay an edge of a drive signal of the first switch so as to provide an edge delayed version of the drive signal of the first switch, and wherein the overload protection circuit is further adapted to turn off the first switch based on the edge delayed version of the drive signal of the first switch.

5. The overload protection circuit of claim 2, wherein the overload protection circuit is further adapted to detect the voltage across the second switch, and to turn off the second switch based on whether the detected voltage exceeds a second threshold voltage.

6. The overload protection circuit of claim 5, comprising a second edge delay unit adapted to delay an edge of a drive signal of the second switch so as to provide an edge delayed version of the drive signal of the second switch, and wherein the overload protection circuit is further adapted to turn off the second switch based on the edge delayed version of the drive signal of the second switch.

7. The overload protection circuit of claim 5, wherein the overload protection circuit is further adapted to detect whether the second switch is off, and to reset the oscillator arrangement based on whether the second switch is detected to be off.

8. The overload protection circuit of claim 1, comprising a first voltage comparator adapted to compare a voltage across the first switch with a threshold voltage and to output a signal according to the result of the comparison.

9. The overload protection circuit of claim 8, wherein the output signal of the first comparator is provided to the controller via an AND gate, the output signal being provided to a first input of the AND gate, and an edge delayed version of the drive signal of the first switch being provided to a second input of the AND gate.

10. A power supply circuit for a fluorescent lamp comprising an overload protection circuit according to claim 1.

11. A circuit overload protection method overload for use with a fluorescent lamp drive circuit having first and second switches connected in series and a controller adapted to switch the switches on and off alternately, the method comprising the steps of:
detecting a voltage across the first switch;
determining if the detected voltage exceeds a first threshold voltage; and
turning off the first switch based on whether the detected voltage is determined to exceed the first threshold voltage.

12. The method of claim 11, wherein the controller comprises an oscillator arrangement having a reset input, and wherein the method further comprises the step of resetting the oscillator arrangement based on whether the detected voltage is determined to exceed the first threshold voltage.

13. The method of claim 11, comprising the further steps of:
detecting a voltage across the second switch;
determining if the detected voltage across the second switch exceeds a second threshold voltage; and
turning off the second switch based on whether the detected voltage across the second switch is determined to exceed the second threshold voltage.

14. (canceled)

15. (canceled)

16. The method of claim 12, comprising the further steps of:
detecting a voltage across the second switch;
determining if the detected voltage across the second switch exceeds a second threshold voltage; and
turning off the second switch based on whether the detected voltage across the second switch is determined to exceed the second threshold voltage.
